(19) United States
(12) Patent Application Publication
(10) Pub. No.: US 2019/0185358 A1
(43) Pub. Date: Jun. 20, 2019

(54) REMOVAL AND INHIBITION OF SCALE AND INHIBITION OF CORROSION BY USE OF MOSS

(71) Applicant: Embro Corporation, St. Louis Park, MN (US)

(72) Inventors: Vance D. Fiegel, Shakopee, MN (US); David R. Knighton, Richmond, MN (US)

(21) Appl. No.: 16/281,445

(22) Filed: Feb. 21, 2019

Related U.S. Application Data
(63) Continuation of application No. 15/420,542, filed on Jan. 31, 2017.
Application No. 15/420,542 is a continuation of application No. 14/989,017, filed on Jan. 6, 2016, now abandoned.
Application No. 14/989,017 is a continuation of application No. 13/659,411, filed on Oct. 24, 2012, now abandoned.
(60) Provisional application No. 61/550,665, filed on Oct. 24, 2011.

(51) Int. Cl. C02F 3/32; C02F 5/10

(52) U.S. Cl. CPC C02F 3/327; C02F 2103/023; C02F 5/10

(57) ABSTRACT

Methods of removing scale and inhibiting scale formation on a surface in an aqueous system are provided that include contacting a surface susceptible to scale formation or having a scale with a solution comprising an amount of a non-decomposed moss effective to remove some or all of the scale or inhibit scale formation on the surface. Methods of inhibiting corrosion on a surface in an aqueous system are provided that include contacting a surface susceptible to corrosion with a solution comprising an amount of a non-decomposed moss effective to inhibit corrosion on the surface.

This application is a continuation of U.S. application Ser. No. 15/420,542, filed Jan. 31, 2017, which is a continuation of U.S. application Ser. No. 14/989,017, filed Jan. 6, 2016, which is a continuation of U.S. Ser. No. 13/659,411, filed Oct. 24, 2012, which claims the benefit of U.S. Provisional Application No. 61/550,665, filed Oct. 24, 2011, entitled “Inhibition and Removal of Scale by Use of Moss”, the contents of each of which are hereby incorporated herein by reference.

### FIELD OF THE INVENTION

This invention relates to methods of removing and inhibiting scale and inhibiting corrosion using moss, particularly sphagnum moss.

### BACKGROUND OF THE INVENTION

The accumulation of scale in artificial water systems creates numerous and significant problems. Depending on the specific system, these problems include increased maintenance expenses and significant operating inefficiencies. Mitigation or removal of scale from within these systems is difficult and typically requires the use of harsh and toxic chemicals. Corrosion is also a problem in artificial water systems, as well as natural water systems.

Previous studies have demonstrated that sphagnum moss significantly inhibits the growth of free-floating (planktonic) bacteria. See U.S. Pat. No. 7,497,947 B2 and U.S. Patent Application Publication No. 2006/0032124 A1, both of which are incorporated by reference herein. “Sphagnum moss” is a generic expression that designates a range of botanical species that co-exist in a sphagnous bog. It should be noted that “peat moss” refers generally to a decomposed or composted sphagnum moss. Sphagnum moss is commonly harvested for use in various products. The petals, and not the stems, of the moss preferably may be harvested. Typically large pieces of plant material (roots, twigs, etc.) are removed and the moss may be processed further after harvesting by forming an aqueous slurry to extract very fine particles. Water is removed from the slurry and the moss is dried. The moss may be compressed prior to packaging or shipment. Various additives may be used to alter the absorption characteristics or mechanical properties of the moss. Because sphagnum moss is readily available and relatively inexpensive, it has been used in a variety of products, primarily for the absorption of fluids.

There is need in the art for products and methods that remove and inhibit scale and that inhibit corrosion.

### SUMMARY OF THE INVENTION

The invention provides a method of removing scale from a surface in an aqueous system comprising contacting a surface having a scale with a solution comprising an amount of a non-decomposed moss effective to remove some or all of the scale from the surface. The invention provides a method of inhibiting scale formation on a surface in an aqueous system comprising contacting a surface susceptible to scale formation with a solution comprising an amount of a non-decomposed moss effective to inhibit scale formation on the surface.

The invention provides a method of inhibiting corrosion on a surface in an aqueous system comprising contacting a surface susceptible to corrosion with a solution comprising an amount of a non-decomposed moss effective to inhibit corrosion on the surface.

It is to be understood that both the foregoing general description and the following detailed description are exemplary and explanatory and are intended to provide further explanation of the invention as claimed.

### BRIEF DESCRIPTION OF THE DRAWINGS

FIG. 1 shows the concentration of calcium in the moss water and the control water for days zero to six for the removal of scale described in Example 1.

FIG. 2 shows the concentrations of calcium in the scale, moss, and water plus pipettes from the final testing on day six for the moss and control for the removal of scale described in Example 1.

FIG. 3 shows the concentrations of calcium in the scale and water from the final testing on day seven for the moss and control for the removal of scale described in Example 2.

FIG. 4 shows the percent scale removal versus the sphagnum moss dose for the removal of scale described in Example 3.

FIGS. 5 to 7 show the corrosion rates for the three cooling towers described in Example 4.

### DETAILED DESCRIPTION OF THE PREFERRED EMBODIMENTS

The invention provides a method of removing scale from a surface in an aqueous system comprising contacting a surface having a scale with a solution comprising an amount of a non-decomposed moss effective to remove some or all of the scale from the surface. In an embodiment, the non-decomposed moss is in the form of leaves or parts of leaves. In one embodiment, the non-decomposed moss is in the form of compressed leaves or parts of leaves.

In an embodiment, the non-decomposed moss is placed in a carrier. In an embodiment, the carrier is a mesh bag. In one embodiment, the non-decomposed moss is placed in a contact chamber. In an embodiment, the aqueous system is a spa, swimming pool, aquarium, splash deck, water tower, holding tank, cooling tower, water bottle, toilet, boiler, ship hull, or steam generator. In one embodiment, the aqueous system is a cooling tower and in another embodiment, the aqueous system is a water tower.

In an embodiment, the solution is prepared and then contacted with the surface. In one embodiment, the solution is prepared in situ by placing non-decomposed moss in the aqueous system. In an embodiment, the amount of non-decomposed moss is effective to remove scale by 30 percent or more after 6 days. In one embodiment, the amount of non-decomposed moss is effective to remove scale by 50 percent or more after 6 days. In an embodiment, the amount of non-decomposed moss is effective to remove scale by 70 percent or more after 6 days. In an embodiment, the moss is selected from the group consisting of sphagnum papillosum, sphagnum cristatum, and mixtures thereof.

The invention provides a method of inhibiting scale formation on a surface in an aqueous system comprising contacting a surface susceptible to scale formation with a solution comprising an amount of a non-decomposed moss effective to inhibit scale formation on the surface. In an embodiment, the non-decomposed moss is in the form of leaves or parts of leaves. In one embodiment, the non-decomposed moss is in the form of compressed leaves or parts of leaves.

In an embodiment, the non-decomposed moss is placed in a carrier. In an embodiment, the carrier is a mesh bag. In one embodiment, the non-decomposed moss is placed in a contact chamber. In an embodiment, the aqueous system is a spa, swimming pool, aquarium, splash deck, water tower, holding tank, cooling tower, water bottle, toilet, boiler, ship hull, or steam generator. In one embodiment, the aqueous system is a cooling tower and in another embodiment, the aqueous system is a water tower.

In an embodiment, the solution is prepared and then contacted with the surface. In one embodiment, the solution is prepared in situ by placing non-decomposed moss in the aqueous system. In an embodiment, the moss is selected from the group consisting of sphagnum papillosum, sphagnum cristatum, and mixtures thereof.

The invention provides a method of inhibiting corrosion on a surface in an aqueous system comprising contacting a surface susceptible to corrosion with a solution comprising an amount of a non-decomposed moss effective to inhibit corrosion on the surface. In an embodiment, the non-decomposed moss is in the form of leaves or parts of leaves. In one embodiment, the non-decomposed moss is in the form of compressed leaves or parts of leaves.

In an embodiment, the non-decomposed moss is placed in a carrier. In an embodiment, the carrier is a mesh bag. In one embodiment, the non-decomposed moss is placed in a contact chamber. In an embodiment, the aqueous system is a spa, swimming pool, aquarium, splash deck, water tower, holding tank, cooling tower, water bottle, toilet, boiler, ship hull, or steam generator. In one embodiment, the aqueous system is a cooling tower and in another embodiment, the aqueous system is a water tower.

In an embodiment, the solution is prepared and then contacted with the surface. In one embodiment, the solution is prepared in situ by placing non-decomposed moss in the aqueous system. In an embodiment, the amount of non-decomposed moss is effective to inhibit corrosion in a cooling tower at least as well as an industry standard corrosion inhibitor over a period of one week. In one embodiment, the industry standard corrosion inhibitor is selected from molybdate-silicate-azole-polydiol, phosphonate-phosphate-azole, or molybdate-phosphonate-polydiol-azole. In an embodiment, the industry standard corrosion inhibitor is molybdate-phosphonate-polydiol-azole. In an embodiment, the moss is selected from the group consisting of sphagnum papillosum, sphagnum cristatum, and mixtures thereof.

In this invention, sphagnum papillosum (S. papillosum) and/or sphagnum cristatum (S. cristatum) preferably can be used to inhibit the formation of scale, remove scale, or inhibit corrosion. The moss can be placed in a carrier. The carrier can be a polymer matrix, a biomatrix, or one or more membranes. In preferred embodiments, the moss is enclosed or encapsulated in a mesh material that prevents the moss from disintegrating in an aqueous environment. Preferred mesh materials include those comprising polymers such as nylon or polypropylene, with mesh sizes ranging from about 0.1 to 1 mm. Polymers are generally preferred because they are inexpensive and may be resistant to degradation.

Suitable for use in this invention are S. papillosum, which can be harvested from bogs in northern Minnesota, U.S.A., and S. cristatum, which is commercially available as a compressed board from Coastpak Holdings, Ltd., Hokitika, New Zealand or from SuperSphag, Ltd., Westland, New Zealand. These species of moss can be used by themselves or together in the devices and systems of this invention. Typically and preferably the moss is cleaned to remove small particles, such as dirt, and larger debris, such as roots. Commercially available moss may be fumigated before it is packaged by a manufacturer in order to destroy seeds.

In a preferred embodiment, the moss is cut by mechanical means into a desired size and shape. The moss preferably is then sterilized by autoclaving, exposure to ethylene oxide, or by other means known to one of skill in the art. Sterilization destroys living organisms in the moss and thus avoids any problems of undesirable or foreign bacteria being introduced into the environment where a device of this invention is used. The moss is then ready for use.

The moss preferably is selected from the group consisting of sphagnum papillosum, sphagnum cristatum, and mixtures thereof. The moss can be in the form of leaves. The moss can be compressed and can be in the form of strips. The moss can be sterilized by autoclaving, sterilized by chemical treatment, or sterilized by treatment with ethylene oxide. The moss can be washed with an acidic solution, especially a solution of acetic acid. The moss can be washed with an acidic solution and then washed with a salt solution. The aqueous system can be any system containing water.

The moss can be prepared by (i) drying non-decomposed moss; and (ii) sterilizing the moss. The method can further comprising compressing the moss, compressing the moss and cutting the moss into strips, sterilizing the moss by autoclaving, chemical treatment, or treatment with ethylene oxide.

The moss can be prepared by (i) contacting non-decomposed moss with an acidic solution; and (ii) drying the moss. The method can comprise contacting the non-decomposed moss with a salt solution after step (i). In one embodiment, the acidic solution is a solution of acetic acid.

### EXAMPLES

### Example 1—Removal of Scale

### Materials

The following materials were used:

### Arsenazo III Reagent Test Kit (Pointe Scientific #C7529)

### Calcium Standard (Pointe Scientific #C7503-STD)

### 3 mL Cuvettes (VWR)

### Spectrophotometer (Beckman #DU 7400)

Eight 600 mL beakers (VWR)
Sphagnum cristatum moss

### 12M HCl (Sigma)

### 10M NaOH (Sigma)

Pasteur pipettes

### Oven

Extruded polypropylene mesh with a pore size of 33 microns ( )

### Method

### Setup:

1. Acid wash all 600 mL beakers with 550 mL distilled H₂O and add HCl until the pH is under 2. Allow to spin at 300 RPM for 30 minutes to dissolve any remaining calcium from the wash. Cover six of them with parafilm for later use.
2. Rinse beakers three times to remove any remaining HCl and calcium.
3. Allow the tap water to run for five minutes, and take a 4 L sample.
4. Add 500 mL of the sample tap water into two 600 ml beakers and raise the temperature to a boil. Boil the water down and turn off the heat. Allow the beakers to cool.
5. Add another 500 mL of tap water from the 4 L sample into both beakers.
6. Place 0.625 g of dry, pressed, and bagged sphagnum moss (in a nylon mesh bag) into one beaker. Add a bag without moss in the control as well. Stabilize them by the addition of 4 pasteur pipettes.
7. Cover with parafilm.
8. Stir these samples at 150 RPM at room temperature. The mesh bags were fixed in place so as to not physically disrupt the scale on the beakers.

### Daily Testing

1. Use an Arsenazo III reagent kit test for calcium by adding 1 ml Arsenazo III into 8 cuvettes.
2. Add 10 uL of the moss water to three of the cuvettes, 10 uL of the control water to three of the cuvettes and 10 uL of the standard to one and keep one as the blank.
3. Allow to sit for at least 1 minute.
4. Read these at A650.
5. If sample is over 150 ppm dilute 1:1 and reread.

### Final Testing

1. Use the other six acid washed and rinsed beakers for the final testing.
2. Using a forceps, shake or scratch the visible calcium from the moss and control bags into the water.
3. Slowly remove the water in each of the test beakers and place in a new 600 mL beaker (now called the “water beakers”).
4. Place pipettes into the water beakers.
5. Remove the moss bag and control bag, and place them in separate beakers.
6. Add 500 mL distilled H₂O, cut the bags open and spin these for 30 minutes on high to beat remaining calcium from the moss and control bag.
7. Place the control bag into a new beaker, strain the moss from the water and place the moss into a new beaker. Add 500 mL distilled H₂O to both beakers.
8. Place the test beakers inside an oven at 60 C and dry the remaining water out.
9. Add 500 mL distilled H₂O to the test beakers.
10. Spin all beakers and adjust the pH of all of them to a pH of 2.
11. Allow 30 minutes to remove all precipitated calcium.
12. Adjust the pH of all samples back within the 6 to 7 range using NaOH.
13. Using the daily testing method, take triplicate measurements of each sample.
14. Compare these by using the formula (absorbance of sample/absorbance of standard) concentration of standard to get parts per million calcium.

### Results

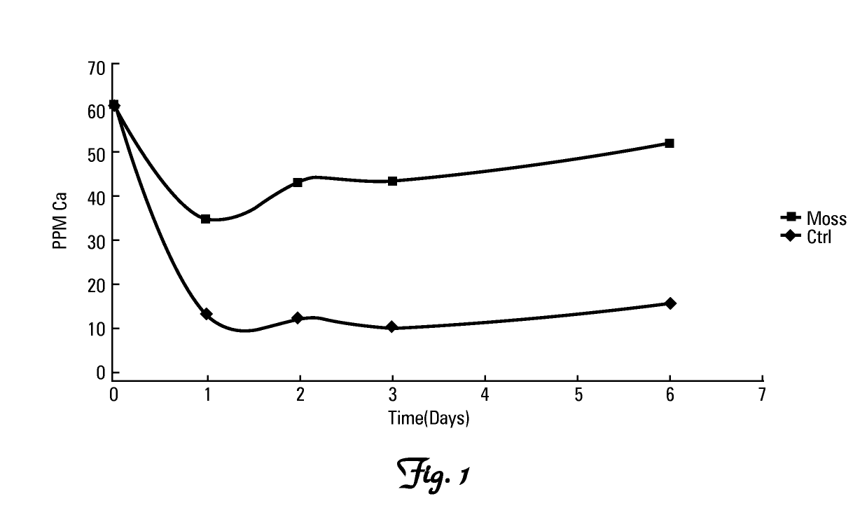

FIG. 1 shows the concentration of calcium in the moss water and the control water for days zero to six. The moss used in this example was from Coastpak Holdings, Ltd., Hokitika, New Zealand. As shown in FIG. 1, the calcium concentrations in the moss water were higher than those in the control water. This occurred because the moss was pulling the calcium in the scale into solution.

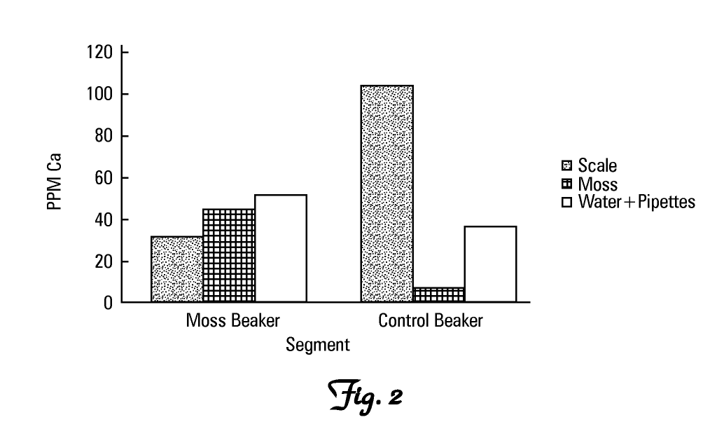

FIG. 2 shows the concentrations of calcium in the scale, moss, and water plus pipettes from the final testing on day six for the moss and control. As shown in FIG. 2, about 70 percent of the scale was removed (102.6 ppm in the control and 31.41 ppm in the moss sample). As shown in FIG. 2, the calcium concentrations for the moss bag were much higher than for the control bag (44.05 ppm in the moss bag and 6.45 ppm in the control bag). These results demonstrate that the moss was effective in removing scale.

The data used to generate the results shown in FIG. 1 are shown below in Table 1.

TABLE 1

| | | Day 1 | | Day 2 | |
|---|---|---|---|---|---|
| | Initial | Moss | Control | Moss | Control |
| Calcium | 0.4307 | 0.2385 | 0.1089 | 0.2628 | 0.0824 |
| | 0.4298 | 0.216 | 0.0781 | 0.3309 | 0.0804 |
| | 0.4339 | 0.2906 | 0.0937 | 0.2849 | 0.0868 |
| pH Standard | 0.7148 | 0.7148 | 0.7148 | 0.6799 | 0.6799 |
| Ppm Ca | 60.36 | 34.75 | 13.09 | 43.07 | 12.24 |

| | |
|---|---|
| Day 3 | Day 6 |

| | Moss | Control | Moss | Control |
|---|---|---|---|---|
| Calcium | 0.2958 | 0.1012 | 0.3405 | 0.1109 |
| | 0.2999 | 0.0623 | 0.3723 | 0.1105 |
| | 0.318 | 0.0535 | 0.3942 | 0.11 |
| pH Standard | 0.7039 | 0.7039 | 0.7132 | 0.7132 |
| Ppm Ca | 43.27 | 10.28 | 51.74 | 15.49 |

The data used to generate the results shown in FIG. 2 are shown below in Table 2.

TABLE 2

| | Day 6 Final | | | |
|---|---|---|---|---|
| | Moss Bag | Ctrl Bag | Moss Beat | CBag Beat |
| Calcium | 0.3457 | 0.0482 | 0.0503 | 0.0145 |
| | 0.2836 | 0.0437 | 0.0477 | 0.0223 |
| | 0.3133 | 0.0462 | 0.0466 | 0.0205 |
| pH Standard | 0.7132 | 0.7132 | 0.7132 | 0.7132 |
| Ppm Ca | 44.05 | 6.45 | 6.76 | 2.68 |
| | Moss Water | Ctrl Water | Moss Scale | Control Scale |
| Calcium | 0.3725 | 0.2324 | 0.2269 | 0.7288 |
| | 0.3588 | 0.2739 | 0.2208 | 0.7364 |
| | 0.354 | 0.2567 | 0.2243 | 0.7301 |
| pH Standard | 0.7132 | 0.7132 | 0.7132 | 0.7132 |
| Ppm Ca | 50.72 | 35.66 | 31.41 | 102.60 |

### Example 2—Removal of Scale

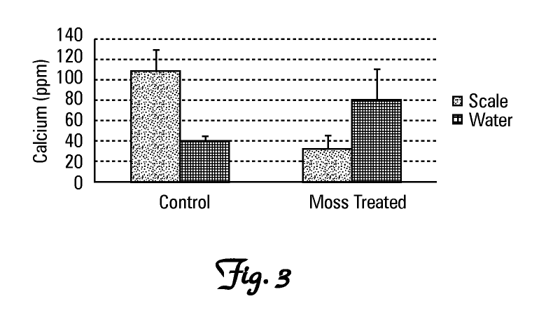

This example is similar to Example 3. The moss used in this example was from Coastpak Holdings, Ltd., Hokitika, New Zealand. FIG. 3 shows the concentration of calcium in the moss water and the control water after seven days. As shown in FIG. 3, the calcium concentrations in the moss water were higher than those in the control water (p<0.04). This occurred because the moss pulled the calcium in the scale into solution. The amount of scale in the control and moss samples is also shown (amount of scale is determined as calcium after solubilization with HCl as described above). The pH of the water in both control and moss treated beakers was periodically monitored during the course of the experiment and remained within 0.1 to 0.2 units of each other.

The results shown in FIG. 3 demonstrate the ability of the moss to remove scale over the course of seven days. The scale remaining in the moss treated beakers (16.05 mg) after seven days was 30% of the untreated control (54.15 mg; p<0.001). Scale removal was also evident by observation over the seven day course.

### Example 3—Removal of Scale

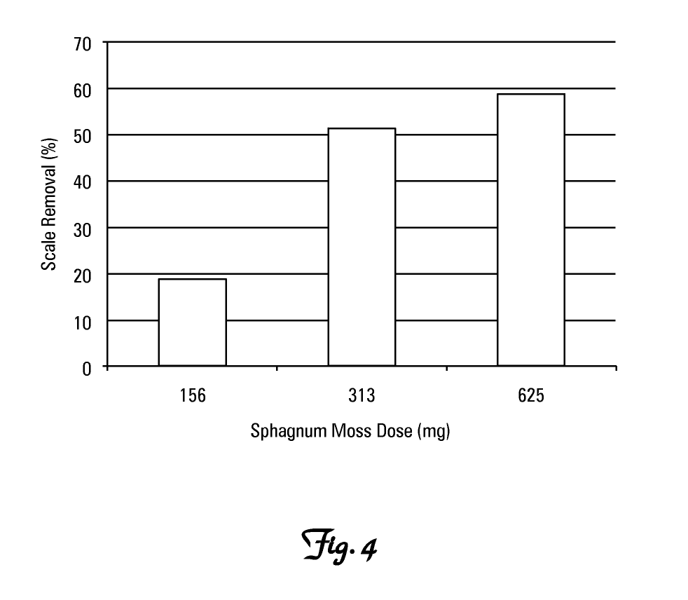

Scale was created by boiling 500 mL of tap water to absolute dryness in acid washed beakers as described above. Tap water (500 mL) was then added back to each beaker and various amounts (156, 313, or 625 mg) of dried, processed Sphagnum cristatum, in a nylon mesh bag, were added. The moss used in this example was from Coastpak Holdings, Ltd., Hokitika, New Zealand. Control beakers received the nylon mesh bag alone. The beakers were stirred at 200 RPM at room temperature for 7 days. The mesh bags were fixed in place so as to not physically disrupt the scale on the beakers. After 7 days, samples were taken from each beaker and calcium measurements made using the Arsenazo III based assay system described above. Following determination of the calcium levels in the water, the beakers were carefully emptied and refilled with 500 mL of distilled water. The water was then acidified to a pH of 2.0 with HCl to solubilise all of the scale remaining on the beakers. The calcium levels were again measured to determine the amount of scale (now as soluble calcium) that had been present on the beakers. The data is shown in FIG. 4. The data is expressed as scale removal in % when compared to beakers receiving empty mesh bags (0% scale removal). 100% scale removal would equal the total calcium removed from the control beakers by acidification.

### Example 4—Inhibition of Corrosion in a Cooling Tower

Three cooling towers from three separate locations were utilized for the evaluation of Sphagnum moss inhibition of corrosion. These locations were selected because they were managed by the same service company and the cooling towers were all manufactured by Evapco, Taneytown, Md., USA, and had water basins that held 200 to 300 gallons. The moss used in this example was from Coastpak Holdings, Ltd., Hokitika, New Zealand.

The study began with the construction of a flow metered, pre-filtered system constructed from a PVC pool filter and stainless steel housing (contact chamber). The contact chamber dimensions were: diameter 11.5 in (29.2 cm), height 20.5 in (52.1 cm), and a capacity of approximately 9 gallons (34 liters). A rotameter after the filter and before the contact chamber allowed for monitoring flow rate through the system. Tower water was drawn off of the pump discharge, passed through the pre-filter, then rotameter, and into the Sphagnum moss contact chamber, before returning to the top of the tower. The contact chamber contained 50 strips (6.5 grams each; 325 grams total) of Sphagnum moss encased in blue, plastic mesh to allow for intimate contact with tower water. Flow rate through the system varied from 2 to 4 gallons per minute throughout the duration of the experiment. The system was equipped with a cooling tower controller and ancillary equipment to provide chemical treatment consisting of scale and corrosion inhibitors, biological dispersant and oxidizing biocide. Included in the control loop were two Metal Samples® linear polarization resistance (LPR) corrosion probes fitted with electrodes for measuring galvanized and carbon (soft) steel corrosion rates. These corrosion probes are available from Metal Samples, Munford, Ala., USA.

The three cooling towers were treated in an industry standard fashion with a “traditional” water treatment program to establish baseline corrosion rates. This included corrosion and scale inhibitors, biocide (2,2-Dibromo-2-cyanoacetamide), and dispersant.

Standard corrosion inhibitors include chromate, molybdate, polysilicate, azoles, polydiol, ortho-phosphate, zinc, polyphosphate, nitrate, phosphonates, and nitrite. Industry standard corrosion inhibitors are usually blends. In general, high phosphate blends are the most economical, low phosphate blends are the next highest in cost, and no phosphate treatment is the most expensive. For facilities where the cooling water system is constructed of several materials, which would include almost all industrial facilities, a program using a blended corrosion inhibitor product is required to obtain satisfactory corrosion protection. For example, adding 2 mg/L of zinc to a phosphonate product at 10 mg/L reduced the corrosion rate on mild steel from 2.2 mils/yr to 0.9 mils/yr. Because of the increase in effectiveness it is common to see programs using mixtures such as molybdate-silicate-azole-polydiol, phosphonate-phosphate-azole, and molybdate-phosphonate-polydiol-azole.

Scale inhibitors include polyacrylate, polymethacrylate, polymaleic, phosphonates, sodium phosphonates, sodium aluminates, chelants (EDTA), copolymers, terpolymers, and polyphosphates.

Biocides include oxidizing biocides such as chlorine, sodium hypochlorite, chlorine dioxide, bromine, ozone, and hydrogen peroxide, and non-oxidizing biocides such as quaternary ammonium salts, 2,2-dibromo-3-nitrilopropionamide, and isothiazolinones.

Dispersants include acrylates, ligonsulphonates, methacrylates, and polycarboxylic acids.

Throughout the experiment, samples were collected periodically and routinely monitored. Instantaneous corrosion rates were read from a Metal Samples® MS-1000 hand-held corrosion monitor, which measures corrosion rates using the linear polarization resistance technique.

The service provider began chemical treatment of all three of the towers on May 5. Sphagnum moss was installed on the system on July 14 and was replaced monthly throughout the duration of the study. The cooling towers ran for the rest of the season with the Sphagnum moss on the system. When the moss was put online, all chemicals, other than the biocide, were turned off. The cooling season ended and the last data point was collected September 28.

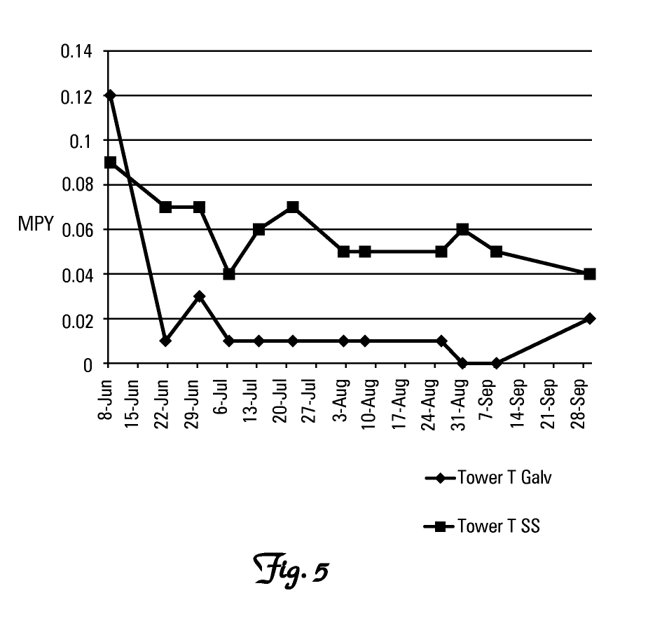

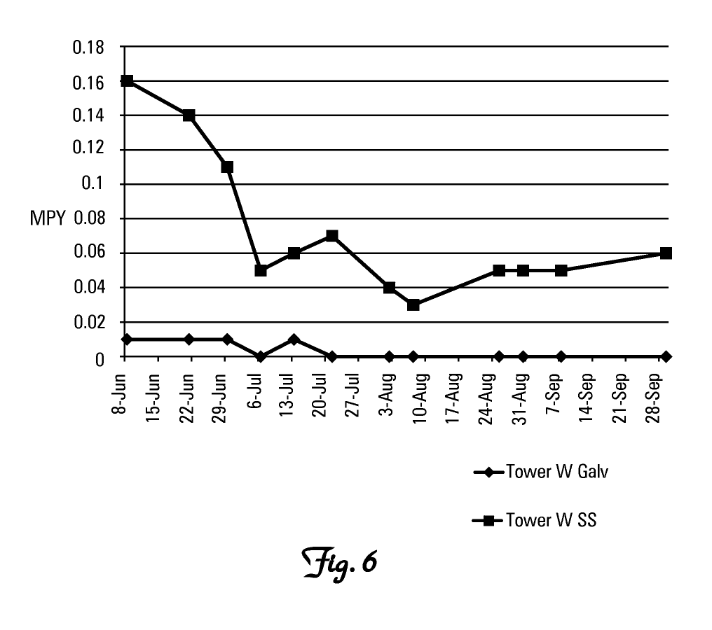

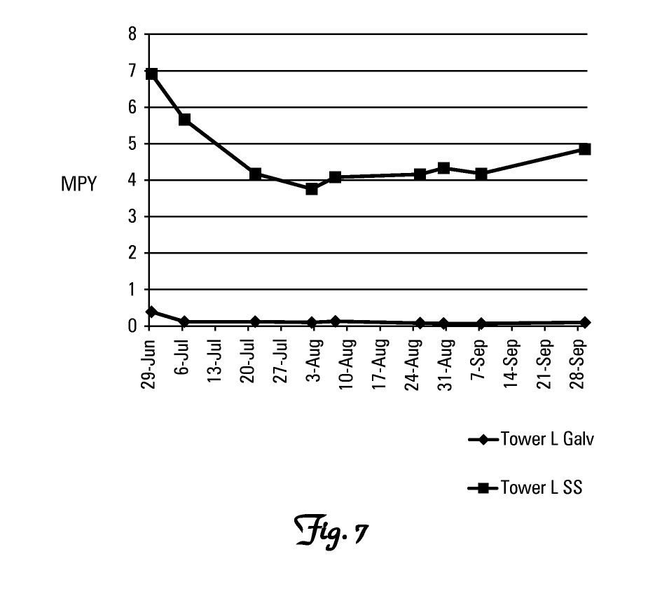

Real time corrosion rates (MPY; mils per year) for two towers (T & W) were taken periodically for 16 weeks. Measurements were made 12 times over the 16 week period. Five measurements were made before the addition of the Sphagnum moss to the system and seven measurements made after the Sphagnum moss was added to the system. For Tower L, measurements were made nine times over a 13 week period. Two measurements were made before the addition of the Sphagnum moss to the system and seven measurements made after the Sphagnum moss was added to the system. FIGS. 5 to 7 depict the corrosion rates found over the 16 week period for each of the three cooling towers. The data clearly demonstrates that Sphagnum moss treatment of the towers was equally effective, if not more so, at inhibiting corrosion as the industry “standard” corrosion inhibitor previously employed. Visual observation of the cooling towers indicated that there was no scale formation even in the absence of the usual scale inhibitor. This indicates that the moss was also acting as an inhibitor of scale formation.

The data used to generate the results shown in FIGS. 5 to 7 are shown below in Table 3.

TABLE 3

| | |
|---|---|
| Tower T | Tower W |

| | Galv | SS | | Galv | SS |
|---|---|---|---|---|---|
| 9-Jun | 0.12 | 0.09 | 9-Jun | 0.01 | 0.16 |
| 22-Jun | 0.01 | 0.07 | 22-Jun | 0.01 | 0.14 |
| 30-Jun | 0.03 | 0.07 | 30-Jun | 0.01 | 0.11 |
| 7-Jul | 0.01 | 0.04 | 7-Jul | 0 | 0.05 |
| 14-Jul | 0.01 | 0.06 | 14-Jul | 0.01 | 0.06 |
| 22-Jul | 0.01 | 0.07 | 22-Jul | 0 | 0.07 |
| 3-Aug | 0.01 | 0.05 | 3-Aug | 0 | 0.04 |
| 8-Aug | 0.01 | 0.05 | 8-Aug | 0 | 0.03 |
| 26-Aug | 0.01 | 0.05 | 26-Aug | 0 | 0.05 |
| 31-Aug | 0 | 0.06 | 31-Aug | 0 | 0.05 |
| 8-Sep | 0 | 0.05 | 8-Sep | 0 | 0.05 |
| 30-Sep | 0.02 | 0.04 | 30-Sep | 0 | 0.06 |

Tower L

| | Galv | SS |
|---|---|---|
| 30-Jun | 0.39 | 6.91 |
| 7-Jul | 0.12 | 5.66 |
| 22-Jul | 0.12 | 4.18 |
| 3-Aug | 0.1 | 3.76 |
| 8-Aug | 0.13 | 4.08 |
| 26-Aug | 0.08 | 4.16 |
| 31-Aug | 0.07 | 4.33 |
| 8-Sep | 0.07 | 4.18 |
| 30-Sep | 0.1 | 4.85 |

The above description and the drawings are provided for the purpose of describing embodiments of the invention and are not intended to limit the scope of the invention in any way. It will be apparent to those skilled in the art that various modifications and variations can be made without departing from the spirit or scope of the invention. Thus, it is intended that the present invention cover the modifications and variations of this invention provided they come within the scope of the appended claims and their equivalents.

What is claimed is:

1. A method of inhibiting corrosion on a surface in an aqueous system comprising contacting a surface susceptible to corrosion with a solution comprising an amount of a non-decomposed moss effective to inhibit corrosion on the surface.

2. The method of claim 1, wherein the non-decomposed moss is in the form of leaves or parts of leaves.

3. The method of claim 2, wherein the non-decomposed moss is in the form of compressed leaves or parts of leaves.

4. The method of claim 1, wherein the non-decomposed moss is placed in a carrier.

5. The method of claim 4, wherein the carrier is a mesh bag.

6. The method of claim 1, wherein the non-decomposed moss is placed in a contact chamber.

7. The method of claim 1, wherein the aqueous system is a spa, swimming pool, aquarium, splash deck, water tower, holding tank, cooling tower, water bottle, toilet, boiler, ship hull, or steam generator.

8. The method of claim 7, wherein the aqueous system is a cooling tower.

9. The method of claim 7, wherein the aqueous system is a water tower.

10. The method of claim 1, wherein the solution is prepared and then contacted with the surface.

11. The method of claim 1, wherein the solution is prepared in situ by placing non-decomposed moss in the aqueous system.

12. The method of claim 1, wherein the amount of non-decomposed moss is effective to inhibit corrosion in a cooling tower at least as well as an industry standard corrosion inhibitor over a period of one week.

13. The method of claim 12, wherein the industry standard corrosion inhibitor is selected from molybdate-silicate-azole-polydiol, phosphonate-phosphate-azole, or molybdate-phosphonate-polydiol-azole.

14. The method of claim 13, wherein the industry standard corrosion inhibitor is molybdate-phosphonate-polydiol-azole.

15. The method of claim 1, wherein the moss is selected from the group consisting of sphagnum papillosum, sphagnum cristatum, and mixtures thereof.

16. A method of removing scale from a surface in an aqueous system comprising contacting a surface having a scale with a solution comprising an amount of a non-decomposed moss effective to remove some or all of the scale from the surface.

17. A method of inhibiting scale formation on a surface in an aqueous system comprising contacting a surface susceptible to scale formation with a solution comprising an amount of a non-decomposed moss effective to inhibit scale formation on the surface.
